(19) United States
(12) Patent Application Publication
(10) Pub. No.: US 2002/0032767 A1
(43) Pub. Date: Mar. 14, 2002

(54) Method and system for handling of information in a computer network

(76) Inventor: Mikael Andersson, Stockholm (SE)

Correspondence Address: BURNS DOANE SWECKER & MATHIS L L P, POST OFFICE BOX 1404, ALEXANDRIA, VA, 22313-1404, US

(21) Appl. No.: 09/742,324

(22) Filed: Dec. 22, 2000

(30) Foreign Application Priority Data
Dec. 23, 1999 (SE) 9904775-5

(51) Int. Cl. G06F 15/16; G06F 15/173

(52) U.S. Cl. 709/224; 709/218

(57) ABSTRACT

A method, a software robot and a system for measuring advertising on a computer network, such as the Internet. The variety of advertisements is examined at certain addresses and advertisements are then automatically looked for and their frequency is registered. Combined with manual classification of advertisements and statistics as regards the visits and prices for advertising, it is possible to assemble current statistics about advertising, both regarding volume and exposures.

FIG. 2 for publication

### TECHNICAL FIELD

The present invention relates to a method and system for obtaining and treating information associated with resources of data in computer networks.

### BACKGROUND

As the number of web sites on the Internet increases, advertising on web sites becomes a more and more important activity. At present there are no tools for monitoring and treating information about advertising activities on the Internet.

### SUMMARY OF THE INVENTION

An object of the invention is thus to tackle the problem of providing detailed, general and current information about advertising activities on, for instance, web sites.

In accordance with claims 1, 8 and 9, the invention shows a method, a software robot and a system for measuring advertising on a copmuter network, such as the Internet. The variety of advertisements is examined at certain addresses and advertisements are then automatically looked for and their frequency is registered. Combined with manual classification of advertisements and statistics as regards the number of visitors and prices for advertising, it is possible to assemble current statistics about advertising, both regarding volume and exposure.

The invention comprises three parts which together gives a system its functionality.

A robot which every hour, day and night, examines a number of web sites and looks for what presumably are advertisements. All such possible advertisements are saved in a database, for example, at a service provider for later classification. The robot also registers the exposure frequency of the advertisements.

An administrative part for classifying advertisements and for completing the system with other information, primarily statistics as regards the number of visits and advertisement prices.

An online part where the users of the system may study current statistics.

Briefly, the invention supplies information as to what advertisements are shown where and with what frequency. When this information is combined with statistics as regards the number of visits (the number of visits per web site) and the price per exposure, a picture is given of both advertisement exposures and investments.

Robot

A part of the invention is a so-called robot—a program which is run without the intervention of a user—which looks for presumed advertisements on a set of web sites. The robot starts every hour, day and night, a web-surfing session where it looks for advertisements.

The robot is configured to surf to a set of addresses and then looks for, based on a set of rules of what characterizes an advertisement, everything that can be, for instance, banner ads. This is a complex algorithm which today comprises an analysis of each web page in order to find all parts of the page which can be advertisements. Each presumed advertisement is analysed by the robot with respect to size, location and information about the link which is connected to the advertisement.

All the found advertisements are given a unique identity by means of a check sum which is calculated by the program and which is stored in a database. This entails that the robot recognizes advertisements that are already known by the system. New, and thus unknown advertisements, are stored for classification.

The robot may also be provided with support for cookies, that is, allowing to measure the frequency of advertisements that are shown a number of times per unique visitor.

Certainly, a robot can be configured to, instead of recognizing advertising, recognize other activities on a web site, such as activities on a discussion forum, for instance, chat sites.

Classification

The administrators of the sytem can at any time see how many new advertisements the robot has found. These are then classified according to product, advertiser of product, product group, unless it turns out that what the robot has found has been something else than an advertisement.

In the administrative interface the administrators can also add and remove addresses which the robot is looking at and import other information to the system. The most important information concerns visiting statistics and advertisement prices.

Online Part

In the online part diagrams and statistics are presented as regards the development of the advertising on the various web sites that the robot examines. Examples of statistics are what banners are the most common ones, what advertisers who spend most money and what the distribution is like between different lines of business.

### SHORT DESCRIPTION OF THE FIGURES

FIGS. 1a-c show a database structure according to the invention.

FIG. 2 shows a schematic diagram of a method according to the invention.

FIG. 3 shows a class diagram according to the invention.

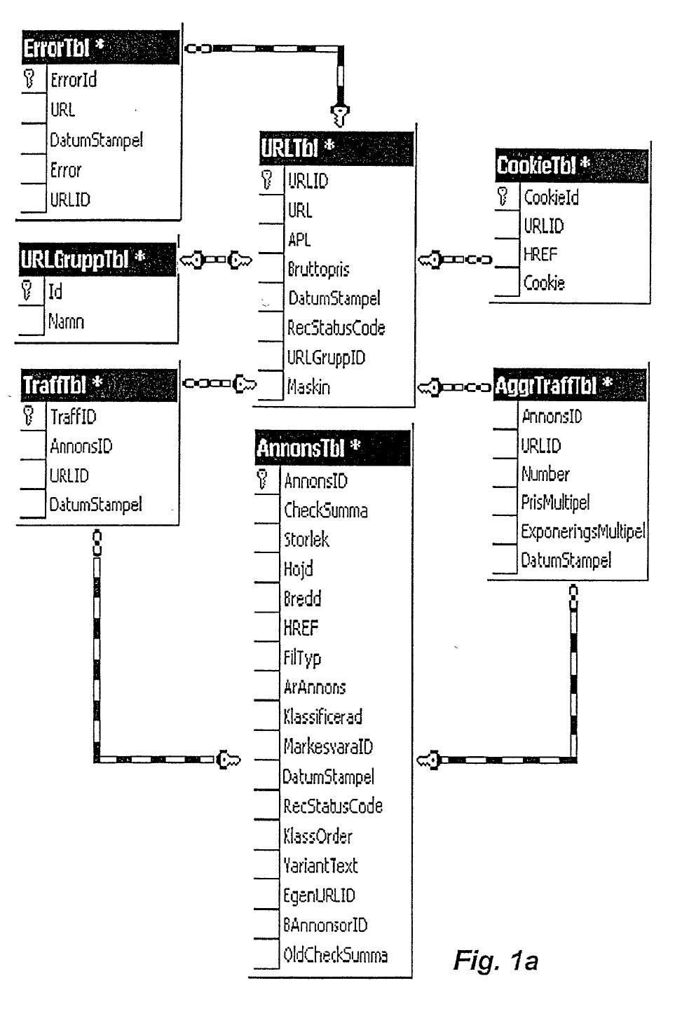

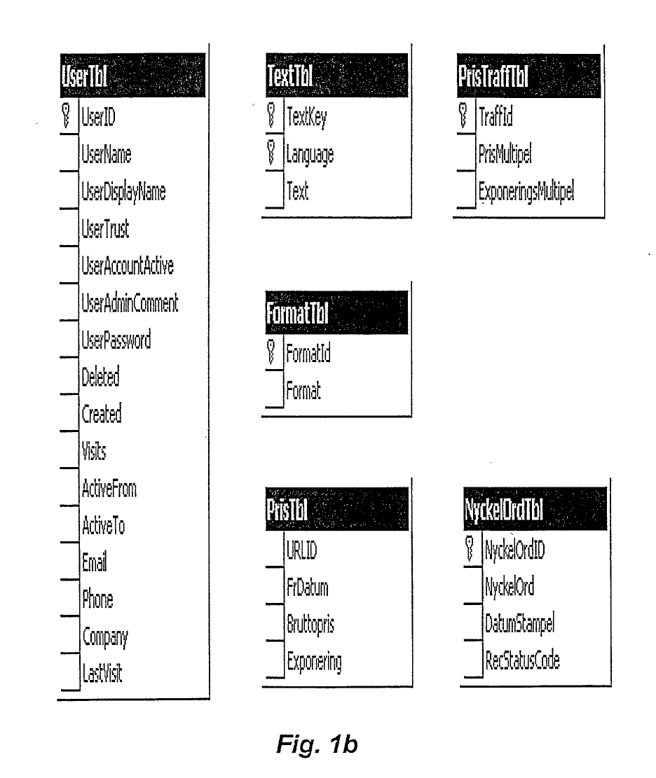

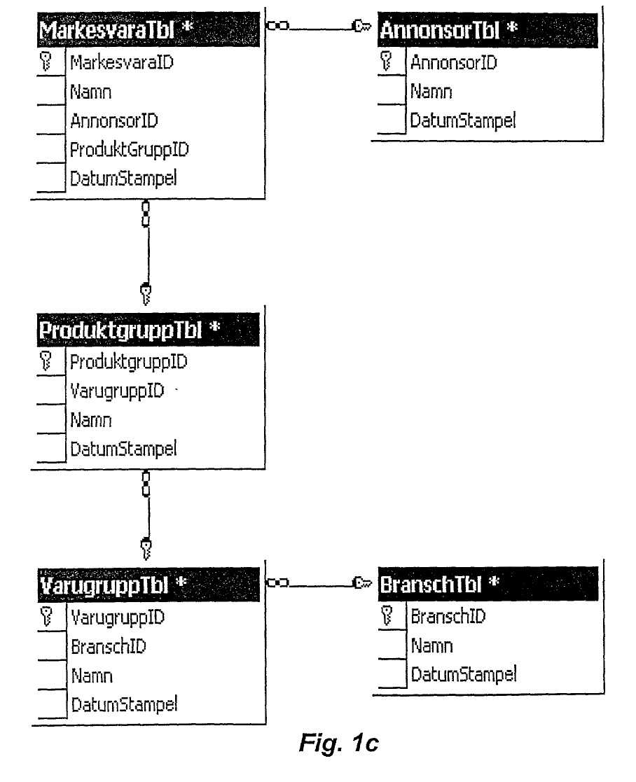

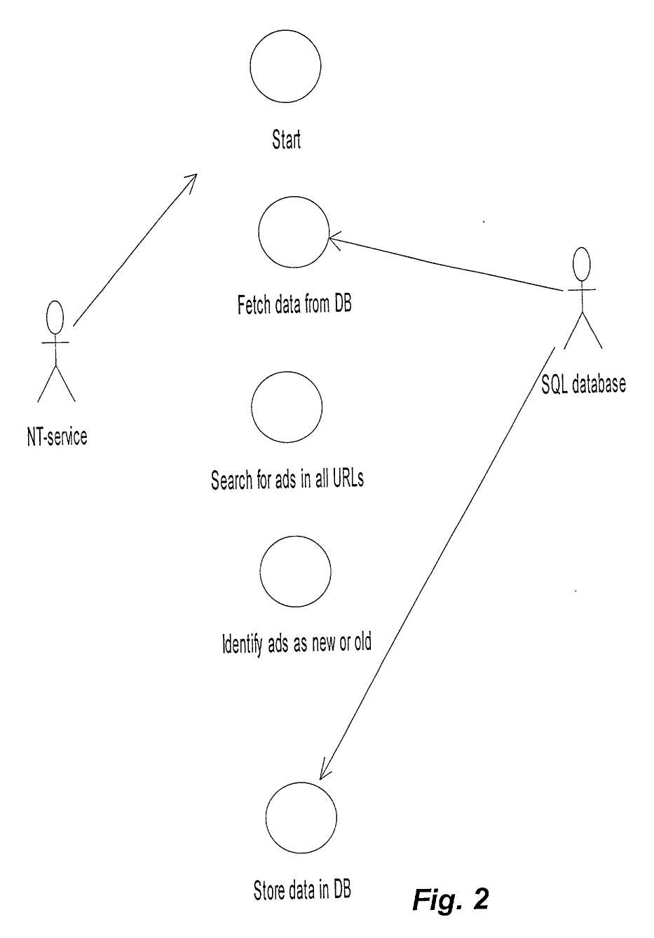

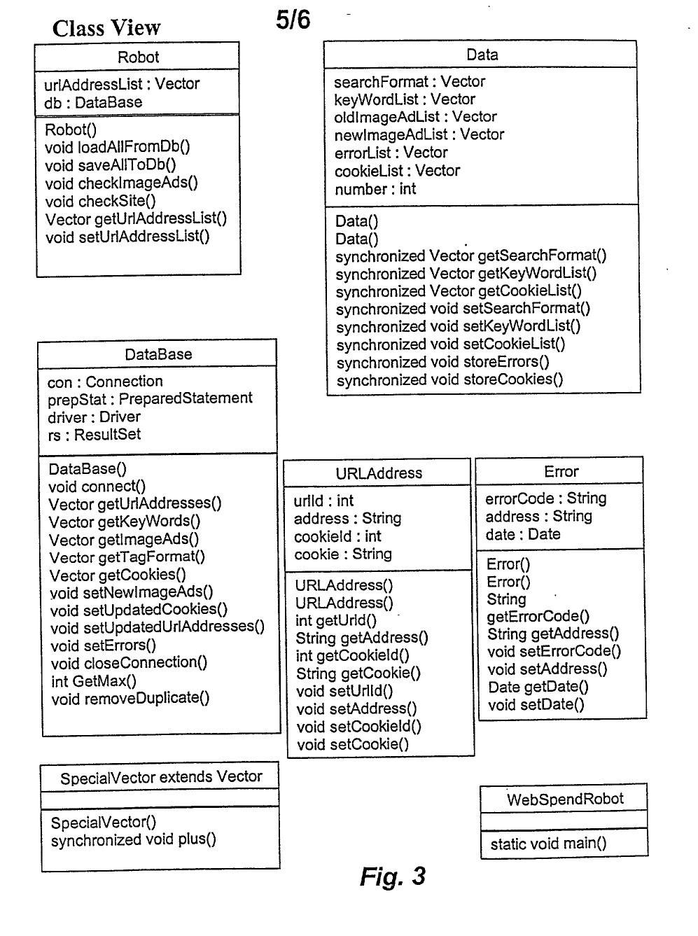

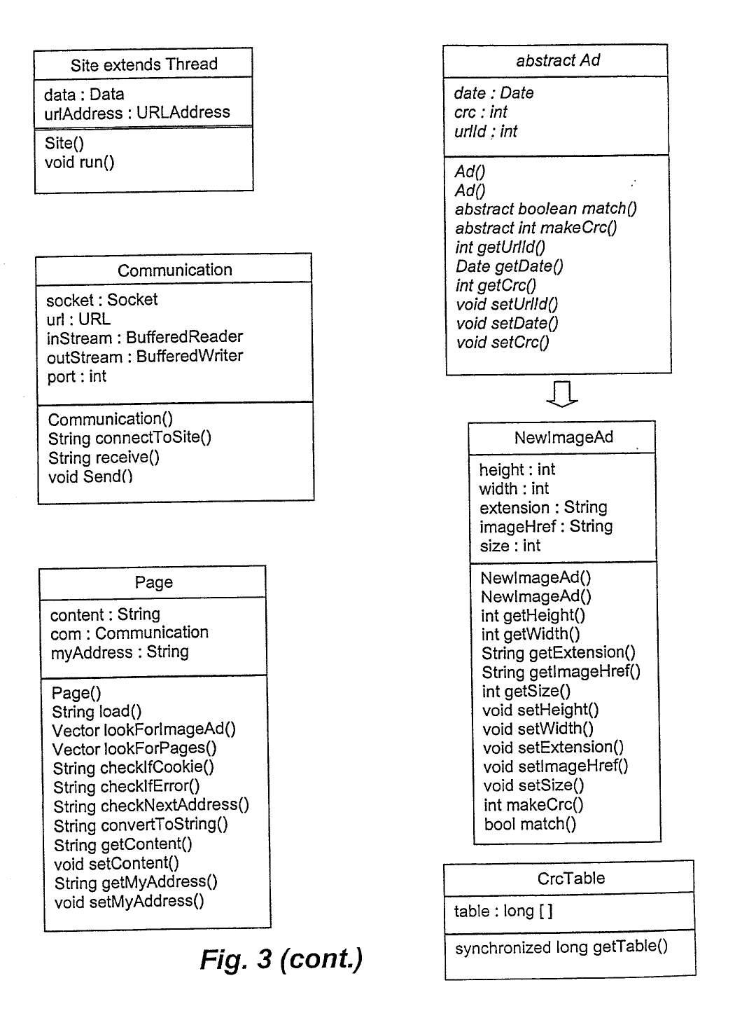

### PREFERRED EMBODIMENTS

In the following embodiments of the invention will be described, the embodiments preferably being implemented in one or more computers which are connected to a computer network such as the Internet.

General Information

A web service according to the invention consists of, and depends on, a number of individual parts. The robot collects information about the advertising which is stored in the database, where it is put together, aggregated, to the form which the web service needs. The following document gives a general view of the web service.

The web service itself contains a number of different parts and aspects.

Graphs and Lists

These fetch data from the database according to indicated choices (numbers from AggrTraffTbl, names and the like from various other tables, such as AnnonsorTbl, UrlTbl, MarkesvaraTbl, etc.). The data is shown either in lists (tables) or graphs which are created by means of AspChart. The main part of the web service is present to handle this.

Classification

The classification is used to classify newly arrived advertisements with respect to the fact that it is indeed and advertisement and, if this is the case, with respect to what trademark is advertised, as well as with respect to advertiser and advertiser of a product. Before the advertisements can be shown in graphs or lists, they have to be classified. This means that the classification has to take place regularly to make the system function properly.

Various Administration

Examples of administration are URL Administration, URL Groups, Key words. These are essentially web interfaces of the current tables in the database (UrlTbl, UrlGruppTbl, NyckelordTbl, UserTbl, etc.).

User Handling

The user must log-on in order to access most of the pages in the system. Moreover, various information about the user is stored (see UserTbl).

Text Handling for Different Languages

All the texts of the web service are stored in the database (TextTbl) and are fetched dynamically owing to what language the user has chosen. This also makes it possible to change most of the texts in the system directly in the web service.

System Information

A number of pages show current information front the database as regards the function of the robot and the information it fetches (Trafftbl, etc.).

Technical Platform

The web service is developed in ASP (Active Server Pages) for Microsoft Internet information Server version 4.0 and Microsoft SQL Server 7.0. The robot is developed in Java, see separate document. The component AspChart from ServerObjects, Inc (http://www.serverobjects.com) is used to make the graphs.

Aggregation

The information shown in the system emanates from a table having aggregated information (AggrTraffTbl). The table is created from untreated data that the robot gives and tells about all the individual instances advertisements have been encountered (TraffTbl), which is put together for each week and for advertisements and web sites, and, moreover, calculations as regards prices are made in advance. As a result, graphs and other information can be calculated much faster. This is made by a couple of scripts which are run on the SQL Server each might, which then adds new data to the aggregated table (see <data-base>/Data Transformation Services/Local Packages/).

Installation

Web Files

Apart from copying al the web files to a location in the file structure according to the web server, in new installations it may be necessary to adapt strURLRoot in /lib/const.inc. This has to contain the (possible) path under the root of the site where the web service is found For instance, if the web service is under www.effekt.net/webspend/ . . . the value hare should be “webspend/”. Also note that there are a number of (originally empty) libraries which must be created under /files/chart/ where the different graphs are stored.

SQL, Server

Apart from creating all the database tables for the database filled with correct contents, there are a number of scripts used for aggregating which have to be put in correctly. These scripts are in the original installation of the invention located in <database>/Data Transformation Services/Local Packages/. The scripts also must be made to be run, for instance every night. There has to be a correct connection string for the database in the file/lib/db.inc.

Robot

As regards the installation of the robot see separate documentation. Note that banners which are saved must be available for the web service in the directory /WebBanners/.

Components

The component AspChart is installed according to known technique.

File specification

Root Directory

The root directory mainly contains the usual HTML-pages for the site.

| Directory | File | Description |
|---|---|---|
| | Global.asa | This file not used by the system. |
| | Index.asp | Main file for the site. A frame file |
| | Kontakt.asp | Page for the site (the main frame) |
| | Loggedon.asp | Page for the site (the main frame) |
| | Main.asp | Page for the site (the main frame) |
| | Main2.asp | Page for the site (the main frame) |
| | Message.asp | Page to show various messages |
| | Metod.asp | Page for the site (the main frame) |
| | Topp.asp | Page for the site (the upper frame) |
| | foretagen.asp | Page for the site (the main frame) |
| | prenumerant.asp | Page for the site (the main frame) |
| | registrerasajt.asp | Page for the site, to register a site |
| | registrerasajt_skicka.asp | Handles the input from |
| | | registrerasajt.asp |
| | switch_language.asp | Switches the language. Is linked to |
| | | from the flags in Topp.asp |
| | synpunkter.asp | Page for the site (the main |
| | | window) |
| Admin/ | | |

Admln/

The Admin directory contains various types of administrative functions.

| Directory | File | Description |
|---|---|---|
| Admin/ | GroupEdit.asp | Modify a URL group (in |
| | | URLGruppTbl) |
| | GroupList.asp | List URL groups (in |
| | | URLGruppTbl) |
| | Groupadd.asp | Add a URL group (to |
| | | URLGruppTbl) |
| | KeywordAdd.asp | Add a key word (to NyckelordTbl) |
| | KeywordDelete.asp | Remove a key word (in |
| | | NyckelordTbl) |
| | KeywordEdit.asp | Modify a key ward (in |
| | | NyckelordTbl) |
| | KeywordList.asp | List key words (in NyckelordTbl) |
| | URLDelete.asp | Remove a URL/APL (in URLTbl) |
| | Urladd.asp | Add a URL/APL (to URLTbl) |
| | Urledit.asp | Modify a URL/APL (in URLTbl) |
| | Urllist.asp | List URL/APL (in URLTbl) |
| | Usradmin.asp | List users (in UserTbl) |
| | Usrchng.asp | Handle modifications and |
| | | additions, in Us-radmin.asp and |
| | | Usredit.asp |
| | Usrdel.asp | Remove a user (from UserTbl) |
| | Usredit.asp | Modify a user, send the form to |
| | | Usrchng.asp |
| | check_annonstbl.asp | Information page about the |
| | | contents of AnnonsTbl |
| | check_errortbl.asp | Information page about the |
| | | contents or ErrorTbl |
| | check_robot.asp | Information page about the number |
| | | of found bits per site |
| | check_traff.asp | Information page about the |
| | | inbound hits |
| | check_trafftbl.asp | Information page about the |
| | | contents of raffTbl |
| | check_trafftbl_spec.asp | Information page, linked to by |
| | | check_robot.asp |
| | text_admin.asp | Administration of texts (in |
| | | TextTbl) |
| Chart/ | | |

The Chart directory contains the various graphs and lists in the system. In general, each graph uses two files, an .inc file in which the actual calculation of the graph is handled, and an .asp file where the web page and the graph are shown.

| Directory | File | Description |
|---|---|---|
| Chart/ | Chart.inc | General graph handling and definitions |
| | chartAPLSelected.inc | Graph, calculation |
| | chartAPLTopp.asp | Top-ten sites, page |
| | chartAPLTopp.inc | Top-ten sites, calculation |
| | chartAPLToppVecka.asp | Top-ten sites, page, “one week free version” |
| | ChartAnnonseringUtveckling.asp | Banner advertising evolution, page |
| | chartAnnonseringUtveckling.inc | Banner advertising evolution, calculation |
| | chartAnnonsorOmsattning.asp | Top-ten advertisers, page |
| | chartAnnonsorOmsattning.inc | Top-ten advertisers, calculation |
| | chartAnnonsorOmsattningVecka.inc | Top-ten advertisers, page, “one week free version” |
| | chartBranschBarometern.asp | Line of business barometer, page |
| | chartBranschBarometern.inc | Line of business barometer, calculation |
| | chartShareBransch.asp | Share of voice (per line of business), page |
| | chartShareBransch.inc | Share of voice (per line of business), calculation |
| | chartShareOiVoice.asp | Not used |
| | chartShareOiVoice.inc | Not used |
| | chart_utils.inc | Various graph utilities |
| | showAllAPL.asp | Listing, page |
| | showAllAPL.inc | Listing, calculation |
| | showAllAPLsite.asp | Listing, page |
| | showAllAPLsite.inc | Listing, calculation |
| | showAllAnnonsorOmsattning.asp | Listing, page |
| | showAllAnnonsorOmsattning.inc | Listing, calculation |
| | showAnnonsorAktivitet.inc | Listing, calculation |
| | showAnnonsorBanners.asp | Listing, page |
| | showAnnonsorerAktivitet.asp | Listing, page |
| | showAnnonsorerAktivitet.inc | Listing, calculation |
| | showBanners.asp | Listing, page |
| | showBanners.inc | Listing, calculation |
| | showBannersVecka.asp | Listing, page |
| | showBanners_raw.asp | This page lists all advertisements, for classification |
| | showBranschAktivitet.asp | Listing, page |
| | showBranschAktivitet.inc | Listing, calculation |
| | showEnAPL.asp | Listing, page |
| | showEnApL.inc | Listing, calculation |
| | showEnAnnonsorOmsuttning.asp | Listing, page |
| | showEnAnnonsorOmsattning.inc | Listing, calculation |
| | showThisWeekAPL.Inc | Listing, calculation |
| | showannonsoraktivitet.asp | Listing, page |
| | showannonsoraktivitet_raw.asp | Listing, page |
| Inc/ | | |

The Inc directory contains HTML headers and footers which handles large parts of the formatting on the various pages.

| | | |
|---|---|---|
| Directory | File | Description |

| | |
|---|---|
| Inc/ | 2spaltbotten.inc |
| | 2spalttop.inc |
| | Charttop.inc |
| | Texttop.inc |
| | chartbotten.inc |
| | generellbotten.inc |
| | generelltop.inc |
| | textbotten.inc |
| Klass/ | |

The Klass directory contains files which handles the classification of banners.

| Directory | File | Description |
|---|---|---|
| Klass/ | Addgroup.asp | Adds trademarks and groupings |
| | Help.htm | |
| | Klass.asp | Handles all the classifications |
| | Lookup.asp | |
| | addgroup_action.asp | |
| Lib/ | | |

The Lib direction contains help functions of different types.

| Directory | File | Description |
|---|---|---|
| Lib/ | Admin.inc | Handles the log on procedure and |
| | | controls access rights (admin) |
| | Const.inc | Various constants, etc. |
| | Db.inc | Data source, database functions |
| | Logon.asp | Handles parts of the log on procedure |
| | Logon.inc | Handles parts of the log on procedure |
| | Logout.asp | Logs off a suer |
| | Prim.inc | Functions to access Session( ) |
| | | information |
| | Private.inc | Handles the log on procedure and |
| | | controls access rights (user) |
| | Public.inc | Includes files as admin and private |
| | | but does not require access rights |
| | Utils.inc | Includes other utility files (for histori- |
| | | cal reasons) |
| | db_user_update.asp | Database functions, to store users in |
| | | database |
| | forcelogon.asp | Page which is used to force a log on |
| | | procedure |
| | utils_language.asp | Help functions to handle text |
| | | languages |
| | utils_string.asp | Help functions |
| | utils_time.asp | Help functions |
| | utils_time_week.asp | Help functions |
| | utils_wsold.asp | Help functions, various not classified |

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A method for measuring activity on web sites, comprising the steps of:
examining at least one web site with respect to the presentation of the activity, whereby the activity is identified,
storing information about the identified activities,
providing a user with the stored information.

2. A method as claimed in claim 1, wherein the activity is an advertising activity.

3. A method as claimed in claim 1, wherein the activity is activity in a discussion forum.

4. A method as claimed in claim 2, wherein the advertising activity is in the form of a banner presentation.

5. A method as claimed in claim 2 or 4, comprising the step of classifying the advertisements.

6. A method as claimed in claim 2, 4 or 5, comprising the steps of:
carrying out statistical calculations with respect to the information about the identified advertisements,
presenting statistical information at least partly obtained from the statistical calculations.

7. A method as claimed in any one of claims 1-6, wherein the examination or the web sites is carried out by a software robot which is configurated to web surf to a set of web addresses.

8. A software robot, comprising functions for examiming at least one web site with respect to the presentation of activity, whereby the activity is identified and the information about the activity is provided for storage and presentation.

9. A sofwarc robot as claimed in claim 8, wherein the examination comprises web surfing to a set of web addresses.

10. A system for measuring activity on web sites, comprising:
means for examining at least one web site with respect to the presentation of the activity, whereby the activity is identified,
means for storing information about the identified activities,
means for providing a user with the stored information.
